(19) United States
(12) Patent Application Publication
(10) Pub. No.: US 2025/0313328 A1
(43) Pub. Date: Oct. 9, 2025

(54) STALL-RESISTANT OUTBOARD WING FOR AIRCRAFT

(71) Applicant: Archer Aviation Inc., San Jose, CA (US)

(72) Inventors: Edward BARBER, Bakersfield, CA (US); Puneet SINGH, Irvine, CA (US)

(73) Assignee: Archer Aviation Inc., San Jose, CA (US)

(21) Appl. No.: 19/243,646

(22) Filed: Jun. 19, 2025

Related U.S. Application Data
(63) Continuation of application No. PCT/US2023/018304, filed on Apr. 12, 2023.
(60) Provisional application No. 63/330,836, filed on Apr. 14, 2022.

(51) Int. Cl. B64C 3/38; B64C 29/00; B64C 39/08

(52) U.S. Cl. CPC B64C 3/38; B64C 29/0033; B64C 39/08

(57) ABSTRACT

Principles described herein allow for wings to be optimized for aerodynamic and structural efficiency while reducing planform compromises required to address wing tip stall problems. All-moving outboard wings allow the outboard wing local angle of attack to be changed relative to the inner wing region to avoid tip stall at high aircraft angles of attack, such as that which is required for low-speed flight. During high-speed cruise flight, at low aircraft angle of attack, the outboard wing local angle of attack can be increased to achieve an ideal elliptical lift distribution.

### PRIORITY

This application claims priority to U.S. provisional application having Ser. No. 63/330,836 (filed Apr. 14, 2022). These and all other extrinsic material discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aircraft wings.

### BACKGROUND

The quest for efficient airplanes is subject to aircraft stall considerations. High aspect ratio wings result in more aerodynamically efficient aircraft. An elliptical lift distribution-a wing configuration in which lift tapers off in an elliptical manner at wing stations farther outboard of the wing root—also contributes to aerodynamic efficiency.

With regards to structural efficiency achieving the lightest structure sufficient to meet load requirements-tapered wings are ideal.

However, aerodynamic efficiency and structural efficiency considerations are subject to aircraft stall considerations. For well-behaved stall characteristics, the aircraft's wings must be designed such that the outboard region of the wing does not stall prior to the inboard wing region. If the outer wing region asymmetrically stalls prior to the inboard region of the wing, the aircraft will experience an uncontrolled roll and yaw moment. This may then cause the aircraft to enter an unrecoverable spin.

FIG. 1 illustrates an aircraft 101 comprising conventional high aspect ratio tapered wings 102. Such wing planforms are known to result in desirable structural and aerodynamic efficiencies.

FIG. 2 illustrates a prior art graph 201 showing a lift versus wing station plot for a wing with an elliptical lift distribution. At the wing root (the chart origin), the lift is at a maximum. At wing stations farther outboard from the wing root, the lift decreases in an elliptical trend.

FIG. 3A illustrates a prior art wing planform 301. The prior art chart 302 of FIG. 3B illustrates a coefficient of lift versus wing station distribution necessary for the wing planform of FIG. 3A to achieve an elliptical lift distribution. As shown by FIG. 3B, a constant coefficient of lift across the wing planform of FIG. 3A results in a desirable elliptical lift distribution.

FIG. 3C illustrates a prior art tapered wing planform 303. Prior art chart 304 of FIG. 3D illustrates a coefficient of lift distribution necessary for the wing planform of FIG. 3C to achieve an elliptical lift distribution. As shown in FIG. 3D, the local coefficient of lift for a tapered wing such as the wing planform of FIG. 3C must increase towards the wing tips. By increasing the local coefficient of lift—commonly accomplished by designing the wing section to be twisted to a higher angle of attack—the local angle of attack margin to stall is reduced. At high vehicle angles of attack—whereby the local angle of attack is increased at all wing sections—the wing sections of higher local coefficient of lift will stall earlier than those of lower local coefficient of lift. The wing planform of FIG. 3C—while more structurally efficient than the planform of FIG. 3A—will exhibit poor stall characteristics unless otherwise accounted for.

Conventionally, stall behavior considerations limit how much wings can be optimized for aerodynamic and structural efficiency.

### SUMMARY

A long, tapered wing with an elliptical lift distribution is ideal in terms of aerodynamic and structural efficiency. An elliptical lift distribution, and a long, tapered wing planform will result in maximum wing aerodynamic and weight efficiency.

Principles described herein allow for wings to be optimized for aerodynamic and structural efficiency while reducing planform compromises required to address wing tip stall problems. All-moving outboard wings allow the outboard wing local angle of attack to be changed relative to the inner wing region to avoid tip stall at high aircraft angles of attack, such as that which is required for low-speed flight. During high-speed cruise flight, at low aircraft angle of attack, the outboard wing local angle of attack can be increased to achieve an ideal elliptical lift distribution.

### BRIEF DESCRIPTION OF THE DRAWINGS

FIG. 1 illustrates a prior art aircraft comprising high aspect ratio wing planform.

FIG. 2 is a prior art lift versus wing station diagram corresponding to a wing with an ideal elliptical lift distribution.

FIG. 3A illustrates a prior art elliptical wing planform.

FIG. 3B illustrates a prior art chart showing required coefficient of lift versus blade station required to achieve an elliptical lift distribution from the wing planform of FIG. 3A.

FIG. 3C illustrates a prior art tapered wing planform.

FIG. 3D illustrates a prior art chart showing required coefficient of lift versus blade station to achieve an elliptical lift distribution from the wing planform of FIG. 3C.

FIG. 4 illustrates an aircraft comprising outboard moving wing sections.

FIG. 5 illustrates a set of steps that can be executed by a flight control computer to decrease the outboard wing local angle of attack relative to the inner wing region to avoid tip stall at high aircraft angles of attack as well as optimize aircraft efficiency during low aircraft angle of attack cruise flight.

FIG. 6 illustrates an aircraft comprising outboard moving wings.

FIG. 7 illustrates an aircraft comprising outboard moving wings.

FIG. 8 illustrates a system diagram of an embodiment of a stall resistant outboard wing system.

FIG. 9 illustrates an aircraft comprising an embodiment of a stall resistant outboard wing system.

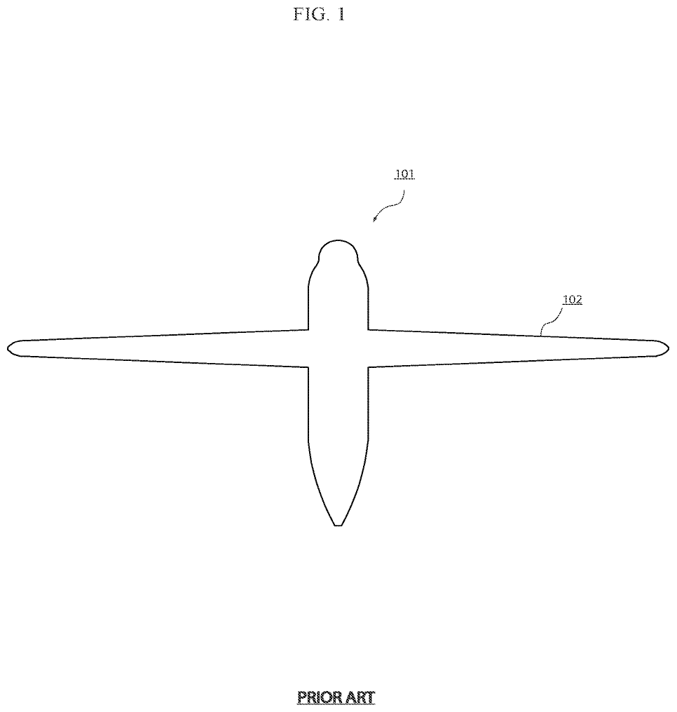

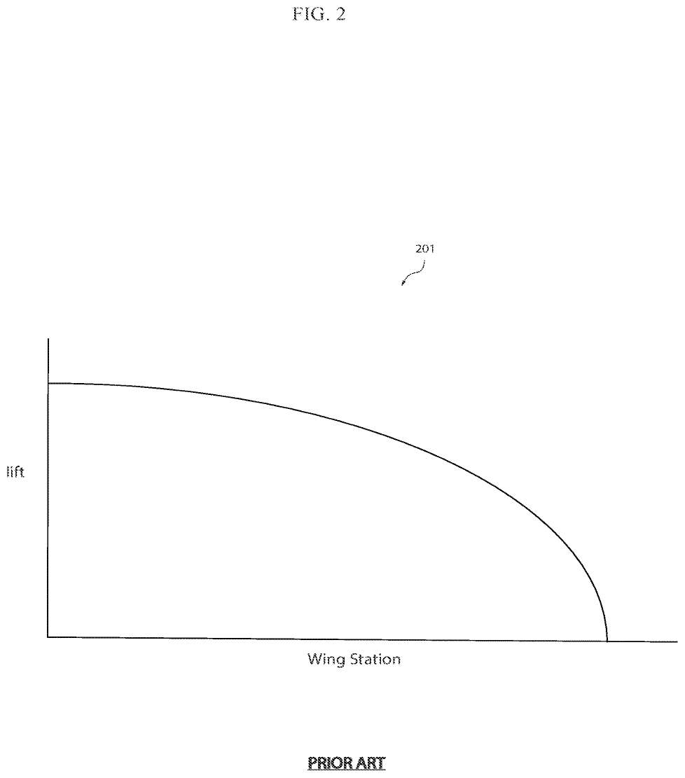

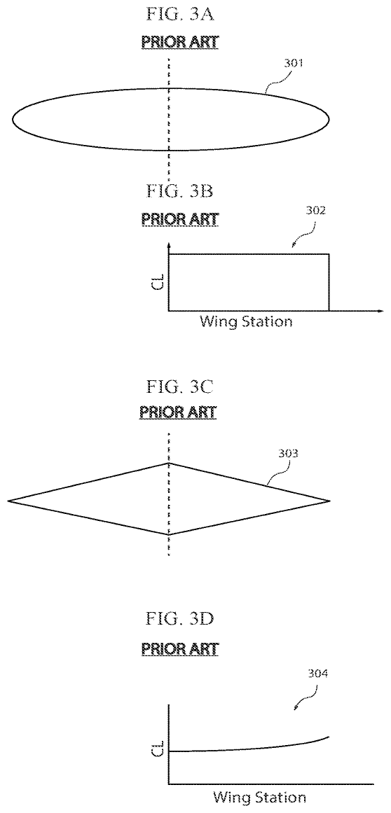

### DETAILED DESCRIPTION

A long, tapered wing with an elliptical lift distribution is ideal in terms of aerodynamic and structural efficiency. An elliptical lift distribution and a long, tapered wing planform will result in maximum wing aerodynamic and weight efficiency.

Principles described herein allow for wings to be optimized for efficiency—with limited wing tip stall considerations—by using all moving outboard wings. The all moving outboard wing local angle of attack can be changed relative to the inner wing region to avoid tip stall at high aircraft angles of attack, such as that which is required for low-speed flight. During high-speed cruise flight, at low aircraft angles of attack, the outboard wing local angle of attack can be increased to achieve an ideal elliptical lift distribution.

In one aspect, described herein is an aircraft comprising an outboard wing section configured to move to a first outboard wing pitch angle at a first aircraft angle of attack and move to a second, lesser, outboard wing pitch angle at a second aircraft angle of attack that is greater than the first aircraft angle of attack.

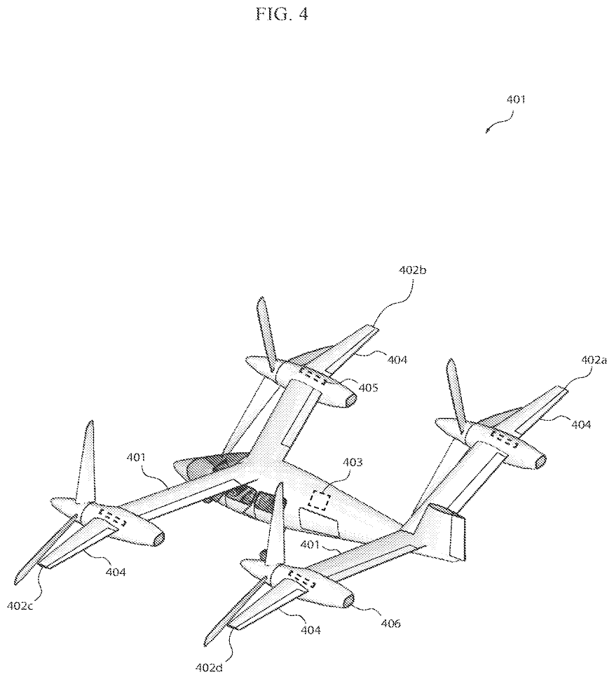

FIG. 4 illustrates an aircraft 401 comprising outboard moving wing sections 402a, 402b, 402c, and 402d. Outboard moving wing sections 402a-d are capable of actuation independent of all other control surfaces.

In the embodiment of FIG. 4, flight control computer 403 is configured to command moving outboard wing actuators 405 to move outboard wing sections 402a-d. In the embodiment of FIG. 4, outboard wing section 402a comprises an entire chord-wise section from a wing section leading edge to a wing section trailing edge. In the embodiment of FIG. 4, the outboard wing section outboard of the nacelle 406 moves. Aileron 404 is configured to move in addition the outboard wing sections, but the aileron pivot point will move with outboard moving wing 402.

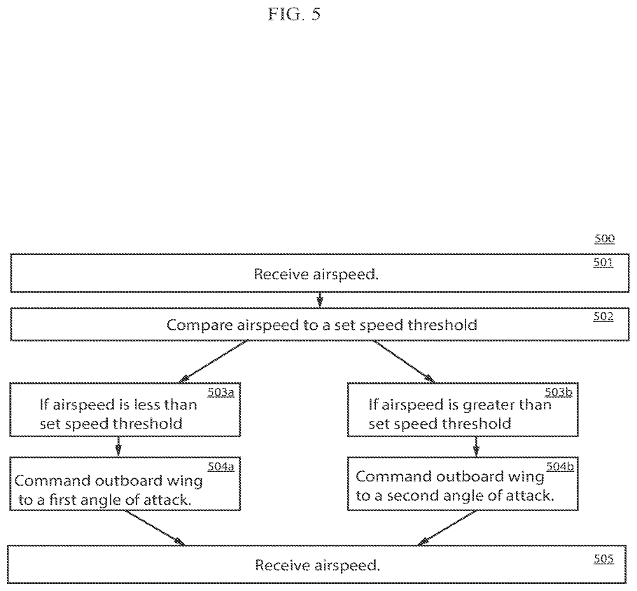

FIG. 5 illustrates steps 500 by which flight control computer 403 of the embodiment of FIG. 4 can increase the efficiency of aircraft 401 by commanding outboard moving wing sections 402a-d. In Step 501, flight control computer 403 receives aircraft angle of attack information for aircraft 401. In Step 502, flight control computer 403 selects—from a lookup table—an associated outboard wing pitch angle for the received aircraft angle of attack information. In step 503, the flight control computer 403 commands the outboard wing tilt actuator to tilt the outboard wing to the selected outboard wing pitch. In step 504, the flight control computer 403 receives an updated angle of attack information.

The aircraft of the embodiment of FIG. 4 comprises a flight control computer configured to command outboard wing 402 to move to a first outboard wing pitch angle at a first aircraft angle of attack and command the outboard wing 402 to move to a second, lesser, outboard wing pitch angle at a second aircraft angle of attack that is greater than the first aircraft angle of attack.

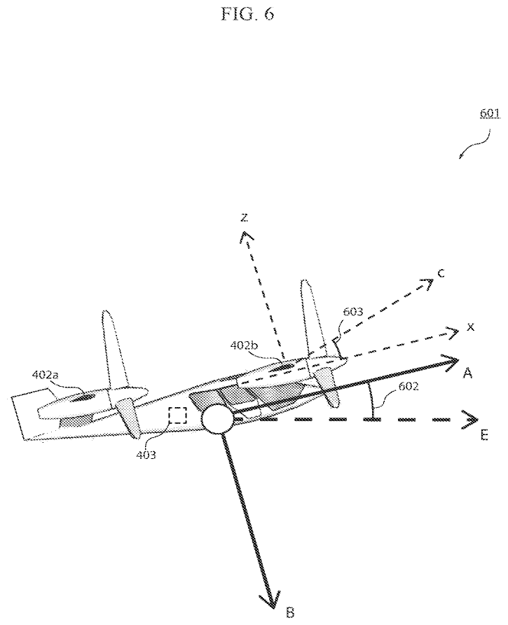

In the embodiment of FIG. 6, flight control computer 403 is configured to rotate moving outboard wing sections 402a-d such that the outboard wing pitch moves inversely to the angle of attack of the aircraft. At level cruise flight the outboard wing sections 402a-d—in conjunction with inboard wing sections 401—achieve an elliptical lift distribution across the wing. This allows for an efficient cruise configuration. As the aircraft slows, the aircraft must pitch up to sustain wingborne flight because the effective angle of attack of the inboard wing section must increase (up to the stall limit of the wing) to maintain sufficient lift.

In the embodiment of FIG. 6, flight control computer 403 is configured to change the pitch of the outboard wing based on the trajectory of the aircraft E relative to the roll axis A of the fuselage.

Illustrated in FIG. 6 is aircraft 601. Flight control computer 403 is configured to compute, using the aircraft angle of attack 602, an outboard wing pitch angle 603. The aircraft outboard wing pitch angle 603 changes opposite to the aircraft angle of attack 602. As the aircraft slows in wingborne flight, the aircraft will pitch up to increase the angle of attack of the inboard wing section 401. The outboard wing sections 402a-d will pitch down relative to the inboard wing sections 401 to decrease the relative angle of attack of the outboard wing sections 402a-d. The outboard wing sections 402a-d will have more stall margin than the inboard wing sections 401 because the outboard wing sections pitch down as the aircraft pitches up.

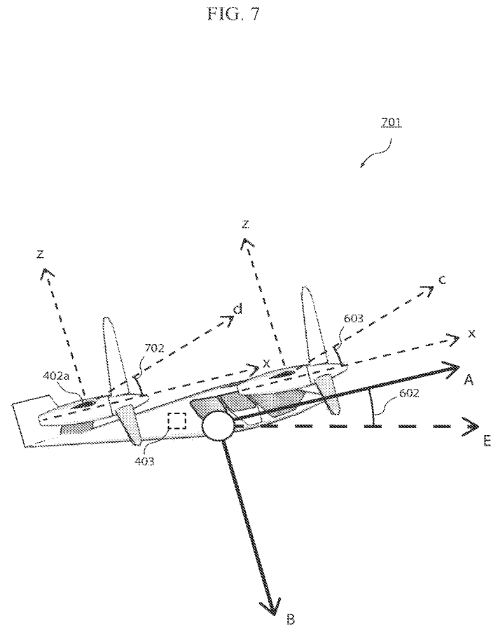

In the embodiment of FIG. 7, the aircraft 701 is a tandem wing quad tiltrotor aircraft, configured to adjust the rear moving outboard wings 402a and 402d more than the front moving outboard wings 402b and 402c during high front wing down-wash flight conditions. The rear wings of tandem wing aircraft will be subject to down wash from the front wings. The downwash changes the effective angle of the free stream air going to the rear wing—thus changing the effective angle of attack of the rear wing. The embodiment of FIG. 7 accounts for the decrease in effective angle of attack when computing a desired outboard wing pitch angle.

Commanding the rear outboard wing as described above can—in some embodiments-result in manufacturing efficiencies. The rear outboard wing and forward outboard wing can use the same part. Any difference in effective angle of attack between the front and rear outboard wing can be corrected for by the flight control computer to achieve a stable lift distribution as well as an efficient lift profile during cruise.

The flight control computer 403, in the embodiment of FIG. 7, can command the outboard moving wing such that the outboard wing pitch angle reduces when the aircraft angle of attack increases. The rear outboard wing pitch angle is reduced proportional to the front outboard wing pitch angle reduction amount minus a factor to account for the front wing downwash—that is to achieve the desired angle of attack of the rear outboard wing.

Different embodiments can determine an outboard pitch angle at a given aircraft angle of attack using different methods, including a look-up table, an equation, a feedback signal or any other suitable method.

The look-up table can be based on the optimized performance of the aircraft at different angle of attacks.

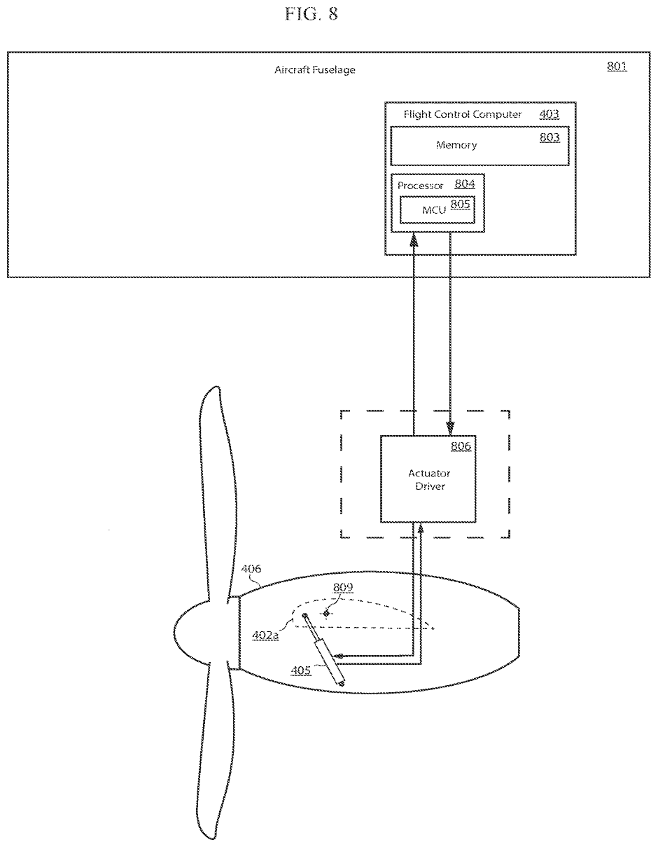

FIG. 8 illustrates a systems diagram of a stall resistant outboard wing system. The system comprises a flight control computer 403 that comprises memory 803 and processor 804. The processor 804 comprises MCU 805. Commands can be sent from processor 804 to actuator driver 806. The actuator driver 806 drives actuator 405. As the actuator 405 is driven to extend and retract, outboard wing 402a is driven to pivot about nacelle pivot point 809. The flight control computer is in the aircraft fuselage 801, but in different embodiments can be in any other suitable location. Other embodiments can use any suitable actuator including, but not limited to a: rotary, linear, electro-mechanical, or hydraulic actuator. Other embodiments may use any suitable flight control computer and driver system or systems.

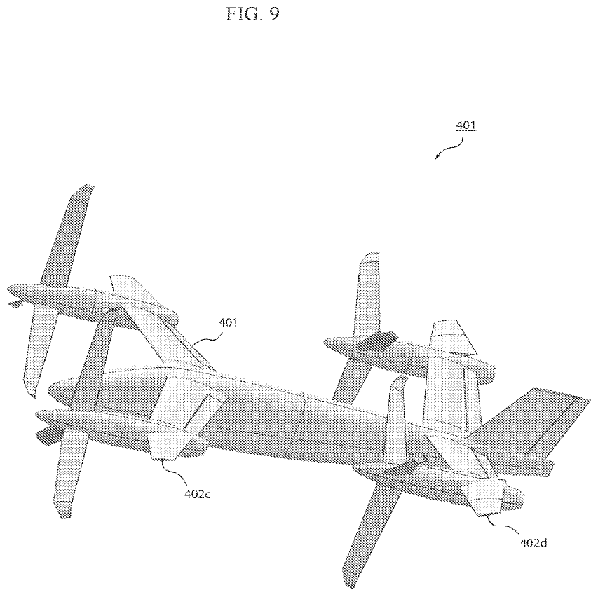

FIG. 9 illustrates an aircraft 401 comprising an embodiment of a stall resistant outboard wing system. Outboard wings 402c and 402d are shown on the near side of the aircraft 401. Shown in FIG. 9, aircraft 401 is pitched up relative to a horizon line. Outboard wings 402c and 402d are pitched down relative to the inboard wing sections. Outboard wing 402d is pitched down less than outboard wing 402c to compensate for the downwash of the front wing.

Principles described herein can be especially well suited for tiltrotor aircraft. Tilt rotor aircraft often have nacelles along the wings. Moveable outboard wings can be useful to minimize proprotor downloading on the wing during vertical flight mode or transition mode.

In some embodiments, the flight control computer can be configured to switch to a low-speed mode to minimize the download on the outboard wings during hover or transition flight. The more the outboard wings are aligned with the proprotor wake, the less downforce there will be. For example, a download minimizing mode could be implemented from 0 knots to 50 knots or when the aircraft is determined to be in rotorborne flight mode.

While embodiments herein describe tiltrotor aircraft with outboard moving wings, application of the principles herein is not limited to tiltrotor aircraft. Any aircraft, including tilt-wing and fixed wing aircraft, can benefit from the principles described herein. For example, a fixed wing jetliner could employ outboard wings to maximize wing structural and aerodynamic efficiencies while providing low speed stability.

Some embodiments may have wings uninterrupted by a nacelle or other structure, but simply has an outboard wing section.

Other embodiments may use a flight control computer configured to move the outboard wings 402a-d based on aircraft speed as opposed to aircraft angle of attack. For example, the aircraft angle of attack will typically be low during high-speed cruise conditions. Thus, some embodiments could change outboard wing pitch based on aircraft speed.

It should be noted that any language directed to flight control computer should be read to include any suitable combination of computing devices, including servers, interfaces, systems, databases, agents, peers, engines, controllers, or other types of computing devices operating individually or collectively. The computing devices may comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed above with respect to the disclosed apparatus. In some embodiments, various servers, systems, databases, or interfaces may exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Aspects of the flight control computer may be located somewhere on the aircraft or anywhere else.

1. An aircraft comprising an outboard wing section configured to move to a first outboard wing pitch angle at a first aircraft angle of attack and move to a second lesser outboard wing pitch angle, at a second aircraft angle of attack that is greater than the first aircraft angle of attack.

2. The aircraft of claim 1, wherein the aircraft comprises a tandem wing aircraft.

3. The aircraft of claim 2, wherein the tandem wing aircraft comprises a tandem wing tiltrotor with four outboard wing sections.

4. The aircraft of claim 1 wherein the aircraft comprises a tiltrotor.

5. The aircraft of claim 1 in which the outboard wing section comprises an entire chord-wise section from a wing section leading edge to a wing section trailing edge.

6. An aircraft including:
an outboard wing section;
an aircraft angle of attack sensor;
a flight control computer comprising non-transitory memory comprising machine readable instructions that include the actions:
command an outboard wing section to move to a first outboard pitch angle upon receipt of a first aircraft angle of attack information indicating a first aircraft angle of attack from the aircraft angle of attack sensor; and
command the outboard wing section to move to a second outboard wing pitch angle, that is less than the first outboard wing pitch angle, based on receipt of a second angle of attack information indicating a second aircraft angle of attack, from the aircraft angle of attack sensor, that is greater than the first aircraft angle of attack.

7. The aircraft of claim 6 wherein the outboard wing section comprises a wing section comprising an entire chord wise section from leading edge to trailing edge.

8. The aircraft of claim 6 wherein the aircraft comprises a tandem wing aircraft comprising four outboard wing sections.

9. The aircraft of claim 8 comprising a rear wing.

10. The aircraft of claim 9, in which the rear wing comprises the outboard wing section.

11. The aircraft of claim 10, in which the flight control computer determines the second outboard wing pitch angle using a front wing downwash factor.

12. A method for improving aircraft stall characteristics, comprising the steps of commanding an outboard wing to a first outboard wing pitch angle at a first aircraft angle of attack; then commanding the outboard wing to a second outboard wing pitch angle that is less than the first outboard wing pitch angle at a second aircraft angle of attack that is greater than the first aircraft angle of attack.
